(19) United States
(12) Patent Application Publication
(10) Pub. No.: US 2022/0171888 A1
(43) Pub. Date: Jun. 2, 2022

(54) METHOD OF PREVENTING USER OPERATIONS, ELECTRONIC DEVICE, AND STORAGE MEDIUM

(71) Applicant: HONGFUJIN PRECISION ELECTRONICS(TIANJIN)CO.,LTD., Tianjin (CN)

(72) Inventor: PING CHEN, Tianjin (CN)

(21) Appl. No.: 17/383,848

(22) Filed: Jul. 23, 2021

(30) Foreign Application Priority Data
Dec. 1, 2020 (CN) 202011388400.6

(51) Int. Cl. G06F 21/84; G06F 3/0484; G06F 9/451

(52) U.S. Cl. CPC G06F 21/84; G06F 2221/2149; G06F 9/451; G06F 3/0484

(57) ABSTRACT

A method of preventing user operations, an electronic device, and a storage medium are disclosed. When running a preset application, the method generates a shielding interface which is always displayed on a topmost layer of a display screen of the electronic device. When the shielding interface is in the top display state, any input instruction is shielded and isolated to prevent operation into the electronic device. A display duration of the shielding interface is recorded, and the shielding interface is closed when the display duration matches the preset duration. According to the present disclosure, the user can be temporarily prevented from operating the electronic device quickly and effectively.

### FIELD

The present disclosure relates to a technical field of electronic security control, specifically a method of preventing user operations, an electronic device, and a storage medium.

### BACKGROUND

When an electronic device is in a preset state (such as an antivirus state), it is necessary to prevent a user from continuing to operate the electronic device. At present, this is done by locking the screen of the electronic device to prevent the user from operating the electronic device. However, after the user enters the correct unlocking password, the user can still use the electronic device, and the prevention against the user from operating the electronic device cannot be achieved.

Therefore, how to quickly and effectively prevent a user from further operation of the electronic device is a technical problem to be solved.

### BRIEF DESCRIPTION OF THE DRAWINGS

FIG. 1 shows a flowchart of a method of preventing user operations provided in an embodiment of the present disclosure.

FIG. 2 shows a schematic structural diagram of a device of preventing user operations provided in an embodiment of the present disclosure.

FIG. 3 shows a schematic structural diagram of an electronic device provided in an embodiment of the present disclosure.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

Optionally, the method of preventing user operations of the present disclosure is applied to one or more electronic devices. The electronic device includes hardware such as, but not limited to, a microprocessor and an Application Specific Integrated Circuit (ASIC), Field-Programmable Gate Array (FPGA), Digital Signal Processor (DSP), embedded devices, etc.

The electronic device may be a device such as a desktop computer, a notebook, a palmtop computer, or a cloud server. The electronic device can interact with users through a keyboard, a mouse, a remote control, a touch panel, or a voice control device.

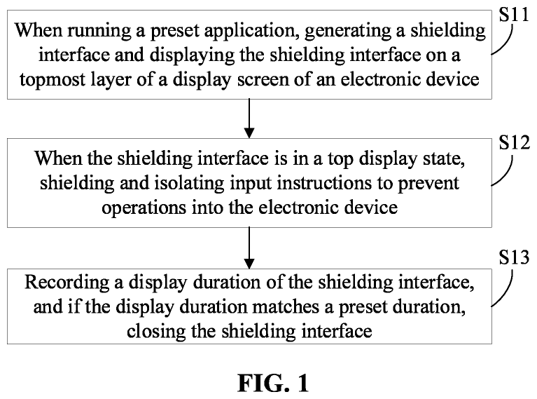

FIG. 1 is a flowchart of a method of preventing user operations in an embodiment of the present disclosure. The method is applied to electronic devices. According to different needs, the order of the steps in the flowchart can be changed, and some can be omitted.

In block S11, when running a preset application, generating a shielding interface and displaying the shielding interface on a topmost layer of a display screen of an electronic device.

When the electronic device runs the preset application, the shielding interface is generated on the display screen of the electronic device and displayed on the topmost layer of the display screen.

For ease of description, a computer is used as an example of the electronic device in the description. Generally, if the preset application program, for example, an antivirus software, or a computer maintenance software, is running on the computer, the computer needs to prevent a user from performing other operations. For another example, when a BIOS of the computer is being updated, the shielding interface can suspend user operations, thereby protecting the computer against introduction of viruses and malware, and against loss of firmware or BIOS integrity for example when updating.

In an embodiment of the present disclosure, in order to quickly and effectively achieve the purpose of the method, the shielding interface can be generated and displayed on the topmost layer of all interfaces in the display screen to cover all the interfaces or windows displayed on the display screen.

In some embodiments, a size of the shielding interface is equal to a size of the display screen.

A Windows Forms Application can be created in a software integrated development tool, for example, a Windows Forms Application can be developed through the Visual Studio development environment provided by Microsoft. C#, Visual Basic, and C++ programming languages can be used to create the shielding interface.

In some embodiments, attributes of the shielding interface can be set. The attributes of the shielding interface include one or more of the following: the shielding interface is displayed on the topmost layer of all interfaces in the display screen, and the size of the shielding interface is equal to the size of the display screen, the shielding interface includes no maximize button, minimize button, or restore button.

In some embodiments, a preset display content can be added to the shielding interface. The preset display content can be set or modified according to actual needs of the user. For example, the preset display content can be “operation not allowed, please wait”.

In block S12, when the shielding interface is in a top display state, shielding and isolating input instructions to prevent operations into the electronic device.

In an embodiment of the present disclosure, in order to prevent the user from closing the shielding interface or hiding the shielding interface through a keyboard or other input device, when the shielding interface is in a top display state, the input instructions can be shielded.

In some embodiments, when the shielding interface is in a top display state, the shielding or isolation of input instructions to prevent operations into the electronic device includes: detecting input instructions; if the input instructions include an instruction to close the shielding interface or an instruction to hide the shielding interface, shielding or isolating the input instructions to prevent operations into the electronic device.

In some embodiments, the input instructions can be detected through an KeyDown event. The KeyDown event is used to check whether the user has clicked a designated key on the keyboard.

If the input instructions include a shortcut key or a combination of shortcut keys that can close or hide the shielding interface (for example, Alt+F4 or window+D), the input instructions are invalidated. The shortcut key Alt+F4 normally corresponds to an instruction to close the shielding interface. The shortcut key window+D normally corresponds to an instruction to hide a shielding interface.

After shielding or isolating input instructions, the method of preventing user operations further includes: refreshing the shielding interface regularly and maintaining the shielding interface at the topmost layer of the all interfaces in the display screen.

In an embodiment of the present disclosure, in order to prevent other interfaces from being displayed on a top layer of the shielded interface, a timer is set in the Windows Forms Application for regular refresh, so that the shielded interface is always kept at the topmost level of the all interfaces in the display screen.

In one embodiment, the electronic device creates a first timer and sets a trigger event interval of the first timer. The trigger event interval can be set or modified according to the actual needs of the user, for example, the trigger event interval can be set to 500 milliseconds. After the first timer is started, the electronic device will trigger an event at regular intervals. This event will execute the following instructions: Topmost=true, Window State=Form Window State. Maximized, and this. Show( ). Wherein, “Topmost=true” means that the shielded interface is displayed on the topmost layer of the all interfaces in the display screen, “Window State=Form Window State. Maximized” means that the size of the shielded interface is equal to the size of the display, and “this. Show( )” means displaying the shielding interface.

By setting the first timer to continuously refresh the shielding interface, the shielding interface is kept in the topmost state, preventing other interfaces from overtopping the shielding interface, and achieving a top-holding effect of the shielding interface.

In another embodiment of the present disclosure, under a condition that the shielding interface is in the top state, if an instruction to display interfaces or windows of other applications on top is received, the instruction can be shielded, and the interfaces or windows of other applications can also be reduced or displayed on a layer next below the shielding interface, to appear as the top display when the shielding interface is no longer in the top state.

In block S13, recording a display duration of the shielding interface, and if the display duration matches a preset duration, closing the shielding interface.

In practical applications, if the preset application is finished, the shielding interface needs to be closed so that the user can use the electronic device normally.

In one embodiment, the display duration of the shielding interface is equal to a running duration of the preset application.

In one embodiment, the electronic device creates a second timer to record the display duration of the shielding interface. The shielding interface is displayed within the preset duration. The preset duration can be set or modified according to the running duration of the preset application, for example, 20 minutes. If the display duration of the shielding interface matches the preset duration, the shielding interface is closed.

In the method flow described in FIG. 1, when the preset application is running, the shielding interface is generated and displayed on the topmost layer of the display screen of the electronic device. When the shielding interface is in the top display state, the input instructions are shielded to prevent the operation of the electronic device; the display duration of the shielding interface is recorded, and if the display duration matches the preset duration, the shielding interface is closed. According to the above method flow, the user can be temporarily prevented from operating the electronic device quickly and effectively.

The above-mentioned embodiments can be applied to a single electronic device. In other embodiments, it can also be applied to a control between a plurality of devices. For example, for a local device and a remote device connected through communication or a network, the method of preventing user operations is applied to the remote device, and the remote device can use this method to realize an operation control of the local device. In addition, the local device can also apply this method to realize a safety protection of the local device, and the remote device can be prevented from controlling operations of the local device.

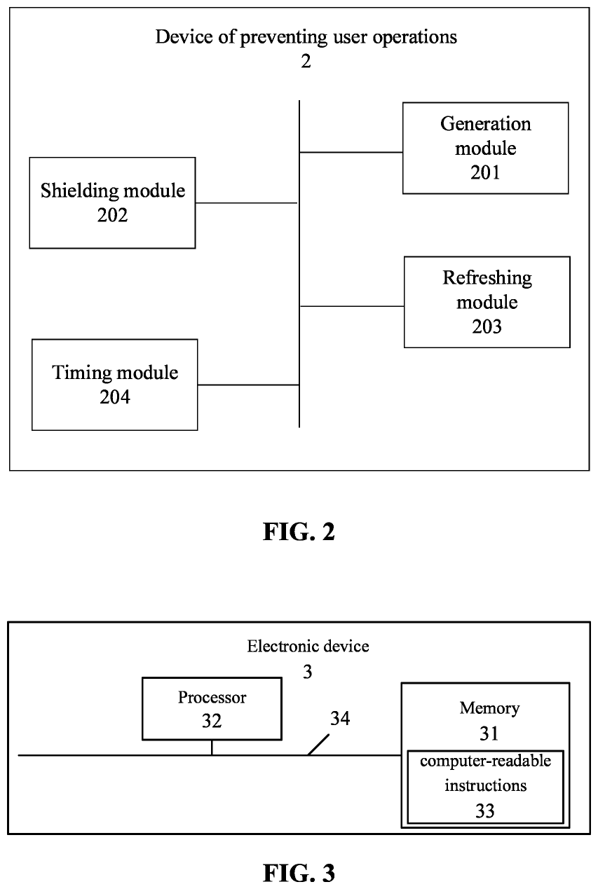

FIG. 2 shows a schematic structural diagram of a device of preventing user operations provided in the embodiment of the present disclosure.

In some embodiments, the device of preventing user operations 2 runs in an electronic device. The device of preventing user operations 2 can include a plurality of function modules consisting of program code segments. The program code of each program code segments in the device of preventing user operations 2 can be stored in a memory and executed by at least one processor to temporarily prevent user operations.

As shown in FIG. 2, the device of preventing user operations 2 can include: a generation module 201, a shielding module 202, a refreshing module 203, and a timing module 204. Modules as referred to in the present disclosure refer to a series of computer-readable instruction segments that can be executed by at least one processor and that are capable of performing fixed functions, which are stored in a memory. In some embodiment, the functions of each module will be detailed.

The above-mentioned integrated unit implemented in a form of software functional modules can be stored in a non-transitory readable storage medium. The above software function modules are stored in a storage medium and includes several instructions for causing an electronic device (which can be a personal computer, a dual-screen device, or a network device) or a processor to execute the method described in various embodiments in the present disclosure.

The generation module 201, when running a preset application, generates a shielding interface and displays the shielding interface on a topmost layer of a display screen of an electronic device.

When the electronic device runs the preset application, the shielding interface is generated on the display screen of the electronic device and displayed on the topmost layer of the display screen.

For ease of description, a computer is used as an example of the electronic device in the description. Generally, if the preset application program, for example, an antivirus software, or a computer maintenance software, is running on the computer, the computer needs to prevent a user from performing other operations. For another example, when a BIOS of the computer is being updated, the shielding interface can suspend user operations, thereby protecting the computer against introduction of viruses and malware, and against loss of firmware or BIOS integrity for example when updating.

In an embodiment of the present disclosure, in order to quickly and effectively achieve the purpose of the device, the shielding interface can be generated and displayed on the topmost layer of all interfaces in the display screen to cover all the interfaces or windows displayed on the display screen.

In some embodiments, a size of the shielding interface is equal to a size of the display screen.

A Windows Forms Application can be created in a software integrated development tool, for example, a Windows Forms Application can be developed through the Visual Studio development environment provided by Microsoft. C#, Visual Basic, and C++ programming languages can be used to create the shielding interface.

In some embodiments, attributes of the shielding interface can be set. The attributes of the shielding interface include one or more of the following: the shielding interface is displayed on the topmost layer of all interfaces in the display screen, and the size of the shielding interface is equal to the size of the display screen, the shielding interface includes no maximize button, minimize button, or restore button.

In some embodiments, a preset display content can be added to the shielding interface. The preset display content can be set or modified according to actual needs of the user. For example, the preset display content can be “operation not allowed, please wait”.

The shielding module 202, when the shielding interface is in a top display state, shields and isolates input instructions to prevent operations into the electronic device.

In an embodiment of the present disclosure, in order to prevent the user from closing the shielding interface or hiding the shielding interface through a keyboard or other input device, when the shielding interface is in a top display state, the input instructions can be shielded.

In some embodiments, when the shielding interface is in a top display state, the shielding module 202 shields or isolates input instructions to prevent operations into the electronic device includes: detecting input instructions; if the input instructions include an instruction to close the shielding interface or an instruction to hide the shielding interface, shielding or isolating the input instructions to prevent operations into the electronic device.

In some embodiments, the input instructions can be detected through an KeyDown event. The KeyDown event is used to check whether the user has clicked a designated key on the keyboard.

If the input instructions include a shortcut key or a combination of shortcut keys that can close or hide the shielding interface (for example, Alt+F4 or window+D), the input instructions are invalidated. The shortcut key Alt+F4 normally corresponds to an instruction to close the shielding interface. The shortcut key window+D normally corresponds to an instruction to hide a shielding interface.

After shielding or isolating input instructions, the device of preventing user operations further includes: a refreshing module 203, is configured to refresh the shielding interface regularly and maintain the shielding interface at the topmost layer of the all interfaces in the display screen.

In an embodiment of the present disclosure, in order to prevent other interfaces from being displayed on a top layer of the shielded interface, a timer is set in the Windows Forms Application for regular refresh, so that the shielded interface is always kept at the topmost level of the all interfaces in the display screen.

In one embodiment, the electronic device creates a first timer and sets a trigger event interval of the first timer. The trigger event interval can be set or modified according to the actual needs of the user, for example, the trigger event interval can be set to 500 milliseconds. After the first timer is started, the electronic device will trigger an event at regular intervals. This event will execute the following instructions: Topmost=true, Window State=Form Window State. Maximized, and this. Show( ). Wherein, “Topmost=true” means that the shielded interface is displayed on the topmost layer of the all interfaces in the display screen, “Window State=Form Window State. Maximized” means that the size of the shielded interface is equal to the size of the display, and “this. Show( )” means displaying the shielding interface.

By setting the first timer to continuously refresh the shielding interface, the shielding interface is kept in the topmost state, preventing other interfaces from overtopping the shielding interface, and achieving a top-holding effect of the shielding interface.

In another embodiment of the present disclosure, under a condition that the shielding interface is in the top state, if an instruction to display interfaces or windows of other applications on top is received, the instruction can be shielded, and the interfaces or windows of other applications can also be reduced or displayed on a layer next below the shielding interface, to appear as the top display when the shielding interface is no longer in the top state.

The timing module 204 records a display duration of the shielding interface, and if the display duration matches a preset duration, closes the shielding interface.

In practical applications, if the preset application is finished, the shielding interface needs to be closed so that the user can use the electronic device normally.

In one embodiment, the display duration of the shielding interface is equal to a running duration of the preset application.

In one embodiment, the electronic device creates a second timer to record the display duration of the shielding interface. The shielding interface is displayed within the preset duration. The preset duration can be set or modified according to the running duration of the preset application, for example, 20 minutes. If the display duration of the shielding interface matches the preset duration, the shielding interface is closed.

In the device flow described in FIG. 2, when the preset application is running, the shielding interface is generated and displayed on the topmost layer of the display screen of the electronic device. When the shielding interface is in the top display state, the input instruction is shielded to prevent the operation of the electronic device; the display duration of the shielding interface is recorded, and if the display duration matches the preset duration, the shielding interface is closed. According to the above method flow, the user can be temporarily prevented from operating the electronic device quickly and effectively.

The embodiment also provides a non-transitory readable storage medium having computer-readable instructions stored therein. The computer-readable instructions are executed by a processor to implement the steps in the above-mentioned method of preventing user operations, such as in steps in blocks S11-S13 shown in FIG. 1:

In block S11: when running a preset application, generating a shielding interface and displaying the shielding interface on a topmost layer of a display screen of an electronic device;

In block S12: when the shielding interface is in a top display state, shielding and isolating input instructions to prevent operations into the electronic device;

In block S13: recording a display duration of the shielding interface, and if the display duration matches a preset duration, closing the shielding interface.

The computer-readable instructions are executed by the processor to realize the functions of each module/unit in the above-mentioned device embodiments, such as the modules 201-204 in FIG. 2:

The generation module 201, when running a preset application, generates a shielding interface and displaying the shielding interface on a topmost layer of a display screen of an electronic device;

The shielding module 202, when the shielding interface is in a top display state, shields and isolates input instructions to prevent operations into the electronic device;

The refreshing module 203 refreshes the shielding interface regularly and maintains the shielding interface at the topmost layer of the all interfaces in the display screen;

The timing module 204 records a display duration of the shielding interface, and if the display duration matches a preset duration, closes the shielding interface.

FIG. 3 is a schematic structural diagram of an electronic device provided in an embodiment of the present disclosure. The electronic device 3 may include: a memory 31, at least one processor 32, and computer-readable instructions 33 stored in the memory 31 and executable on the at least one processor 32, for example, image recognition programs, and at least one communication bus 34. The processor 32 executes the computer-readable instructions 33 to implement the steps in the embodiment of the method of preventing user operations, such as in steps in block S11-S13 shown in FIG. 1. Alternatively, the processor 32 executes the computer-readable instructions 33 to implement the functions of the modules/units in the foregoing device embodiments, such as the modules 201-204 in FIG. 2.

For example, the computer-readable instructions 33 can be divided into one or more modules/units, and the one or more modules/units are stored in the memory 31 and executed by the at least one processor 32. The one or more modules/units can be a series of computer-readable instruction segments capable of performing specific functions, and the instruction segments are used to describe execution processes of the computer-readable instructions 33 in the electronic device 3. For example, the computer-readable instructions can be divided into the generation module 201, the shielding module 202, the refreshing module 203, and the timing module 204 as in FIG. 2.

The electronic device 3 can be an electronic device such as a desktop computer, a notebook, a palmtop computer, and a cloud server. Those skilled in the art will understand that the schematic diagram 3 is only an example of the electronic device 3 and does not constitute a limitation on the electronic device 3. Another electronic device 3 may include more or fewer components than shown in the figures or may combine some components or have different components. For example, the electronic device 3 may further include an input/output device, a network access device, a bus, and the like.

The at least one processor 32 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 32 can be a microprocessor or any conventional processor. The processor 32 is a control center of the electronic device 3 and connects various parts of the entire electronic device 3 by using various interfaces and lines.

The memory 31 can be configured to store the computer-readable instructions 33 and/or modules/units. The processor 32 may run or execute the computer-readable instructions 33 and/or modules/units stored in the memory 31 and may call up data stored in the memory 31 to implement various functions of the electronic device 3. The memory 31 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the electronic device 3. In addition, the memory 31 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the electronic device 3 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions 33. The computer-readable instructions 33 can be stored in a non-transitory readable storage medium. The computer-readable instructions 33, when executed by the processor, may implement the steps of the foregoing method embodiments. The computer-readable instructions 33 include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A method of preventing user operations, applied to an electronic device, the method comprising:
when running a preset application, generating a shielding interface and displaying the shielding interface on a topmost layer of a display screen of the electronic device; and
when the shielding interface is in a top display state, shielding or isolating input instructions into the electronic device thereby preventing operations of the electronic device.

2. The method of preventing user operations according to claim 1, wherein shielding or isolation of input instructions into the electronic device comprises:
detecting input instructions;
if the input instructions comprise an instruction to close the shielding interface or an instruction to hide the shielding interface, shielding or isolating the input instructions.

3. The method of preventing user operations according to claim 1, wherein a size of the shielding interface is equal to a size of the display screen.

4. The method of preventing user operations according to claim 1, further comprising:
setting attributes of the shielding interface; and
adding a preset display content to the shielding interface.

5. The method of preventing user operations according to claim 4, wherein the attributes of the shielding interface comprise:
the shielding interface comprises no maximize button, minimize button, or restore button.

6. The method of preventing user operations according to claim 1, further comprising:
recording a display duration of the shielding interface;
if the display duration matches a preset duration, closing the shielding interface.

7. The method of preventing user operations according to claim 6, wherein the display duration of the shielding interface is equal to a running duration of the preset application.

8. A electronic device comprising a memory and a processor, the memory stores at least one computer-readable instruction, and the processor executes the at least one computer-readable instruction to implement to:
when running a preset application, generate a shielding interface and display the shielding interface on a topmost layer of a display screen of an electronic device; and
when the shielding interface is in a top display state, shield and isolate input instructions to prevent operations into the electronic device.

9. The electronic device according to claim 8, the processor shielding or isolating input instructions comprises by:
detecting input instructions;
if the input instructions comprise an instruction to close the shielding interface or an instruction to hide the shielding interface, shielding or isolating the input instructions.

10. The electronic device according to claim 8, wherein a size of the shielding interface is equal to a size of the display screen.

11. The electronic device according to claim 8, the processor further to:
set attributes of the shielding interface; and
add a preset display content to the shielding interface.

12. The electronic device according to claim 11, wherein the attributes of the shielding interface comprise:
the shielding interface comprises no maximize button, minimize button, or restore button.

13. The electronic device according to claim 8, the processor further to:
record a display duration of the shielding interface;
if the display duration matches a preset duration, close the shielding interface.

14. The electronic device according to claim 13, wherein the display duration of the shielding interface is equal to a running duration of the preset application.

15. A non-transitory storage medium having stored thereon at least one computer-readable instructions that, when the at least one computer-readable instructions are executed by a processor to implement the following steps:
when running a preset application, generating a shielding interface and displaying the shielding interface on a topmost layer of a display screen of an electronic device; and
when the shielding interface is in a top display state, shielding and isolating input instructions to prevent operations into the electronic device.

16. The non-transitory storage medium according to claim 15, wherein the shielding or isolation of input instructions comprises:
detecting input instructions;
if the input instructions comprise an instruction to close the shielding interface or an instruction to hide the shielding interface, shielding or isolating the input instructions.

17. The non-transitory storage medium according to claim 15, wherein a size of the shielding interface is equal to a size of the display screen.

18. The non-transitory storage medium according to claim 15, further comprising:
setting attributes of the shielding interface; and
adding a preset display content to the shielding interface.

19. The non-transitory storage medium according to claim 18, wherein the attributes of the shielding interface comprise:
the shielding interface comprises no maximize button, minimize button, or restore button.

20. The non-transitory storage medium according to claim 15, further comprising:
recording a display duration of the shielding interface;
if the display duration matches a preset duration, closing the shielding interface.
